(19) United States
(12) Patent Application Publication
(10) Pub. No.: US 2026/0274393 A1
(43) Pub. Date: Sep. 17, 2026

(54) UNMANNED AERIAL VEHICLES HAVING A SKELETON AND OUTER SHELL

(71) Applicant: AEVEX AEROSPACE, LLC, Solana Beach, CA (US)

(72) Inventors: Christopher Douglas Rohr, Haymarket, VA (US); Julian William Garcia, Fairfax, VA (US); Harold Alexander Brown, Seattle, WA (US)

(21) Appl. No.: 19/562,002

(22) Filed: Mar. 10, 2026

Related U.S. Application Data
(60) Provisional application No. 63/772,226, filed on Mar. 14, 2025.

(51) Int. Cl. B64C 1/08; B64C 1/12; B64D 37/08; B64F 5/10; B64U 10/25; B64U 20/75

(52) U.S. Cl. CPC B64C 1/08; B64C 1/12; B64D 37/08; B64F 5/10; B64U 10/25; B64U 20/75

(57) ABSTRACT

An aircraft assembly can include a skeleton, including longitudinal members. Each of the longitudinal members can include an outward surface. The aircraft assembly can also include an outer shell formed from outer shell components. Each of the outer shell components can include an inboard surface configured to interface with the outward surface of each of the longitudinal members to restrict against movement of the outer shell components in directions other than along the longitudinal axis.

### CROSS-REFERENCE TO RELATED APPLICATIONS

This Application claims priority to and the benefit of U.S. Provisional Patent Application No. 63/772,226, filed on Mar. 14, 2025, the contents of which are hereby incorporated by reference in its entirety.

### FIELD

The present disclosure generally pertains to a structure of an unmanned aerial vehicle. More specifically, the present disclosure pertains to unmanned aerial vehicles formed from a skeleton and an outer shell.

### BACKGROUND

Unmanned aerial vehicles (UAVs), sometimes referred to as “drones,” are increasingly being used for a wide range of applications. In some applications, an optimal choice for certain characteristics of the UAVs can be heavily mission-dependent. Moreover, in some applications, the needs of a particular mission, or even the need for the mission itself, can become apparent only a short time before the UAVs must be deployed. It would therefore be advantageous to enable portions of UAV related to these mission-dependent characteristics to be selected and rapidly assembled at a site that is relatively close to the desired area of deployment. However, such on-site or near-site rapid assembly also limits an ability to test and verify integration of other UAV systems, such as avionics and propulsion systems. It would therefore also be advantageous to enable certain core systems of the UAV to be pre-assembled and pre-verified in a fashion that also enables rapid selection and final assembly of the mission-related characteristics. These approaches also could be advantages for other types of aircraft.

### SUMMARY

This summary is provided to introduce a selection of concepts in a simplified form that are further described below in the detailed description. This summary is not intended to identify key features of the claimed subject matter, nor is it intended to be used as an aid in determining the scope of the claimed subject matter.

In accordance with an embodiment of the present disclosure, an aircraft assembly is provided. The aircraft assembly can include a skeleton including longitudinal members extending along a longitudinal axis of the aircraft assembly, wherein each of the longitudinal members includes an outward surface. The aircraft assembly can also include an outer shell formed from outer shell components, wherein each of the outer shell components includes an inboard surface, and wherein the inboard surface is configured to interface with the outward surface of each of the longitudinal members to restrict against movement of the outer shell components in directions other than along the longitudinal axis.

In accordance with another embodiment of the present disclosure, a method of assembling an aircraft assembly is provided. The method can include providing a skeleton including longitudinal members extending along a longitudinal axis of the aircraft assembly, wherein each of the longitudinal members includes an outward surface; and coupling outer shell components to the skeleton to form an outer shell, wherein each of the outer shell components includes an inboard surface, and wherein the inboard surface is configured to interface with the outward surface of each of the longitudinal members to restrict against movement of the outer shell components in directions other than along the longitudinal axis.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative examples, in which the principles of the disclosure are utilized, and the accompanying drawings of which:

FIG. 1 illustrates a perspective view of an example aircraft assembly in accordance with one or more embodiments of the present disclosure.

FIG. 2A illustrates a perspective view of an example skeleton that may be used with the aircraft assembly of FIG. 1 in accordance with one or more embodiments of the present disclosure.

FIG. 2B illustrates a sectional view of an example longitudinal member that may be used as part of the skeleton of FIG. 2A in accordance with one or more embodiments of the present disclosure.

FIG. 2C illustrates a perspective view of an example fuel tank that may be used as part of the skeleton of FIG. 2A in accordance with one or more embodiments of the present disclosure.

FIG. 2D illustrates a cutaway view of the fuel tank of FIG. 2C in accordance with one or more embodiments of the present disclosure.

FIG. 3 illustrates a perspective view of an example intermediate assembly, including the skeleton of FIG. 2 and example core components installed thereon, in accordance with one or more embodiments of the present disclosure.

FIG. 4A illustrates a perspective view of an example outer shell that may be used with the aircraft assembly of FIG. 1, formed from example outer shell components coupled to the skeleton of FIG. 2, in accordance with one or more embodiments of the present disclosure.

FIG. 4B illustrates a perspective view of one of the outer shell components of FIG. 4A in accordance with one or more embodiments of the present disclosure.

FIG. 4C illustrates a sectional view of the outer shell component of FIG. 4B in accordance with one or more embodiments of the present disclosure.

FIG. 4D illustrates a perspective detail view of another one of the outer shell components of FIG. 4A coupled to the skeleton of FIG. 2 in accordance with one or more embodiments of the present disclosure.

FIG. 5 is a flow diagram illustrating an example method for assembling an aircraft assembly in accordance with one or more embodiments of the present disclosure.

### DETAILED DESCRIPTION

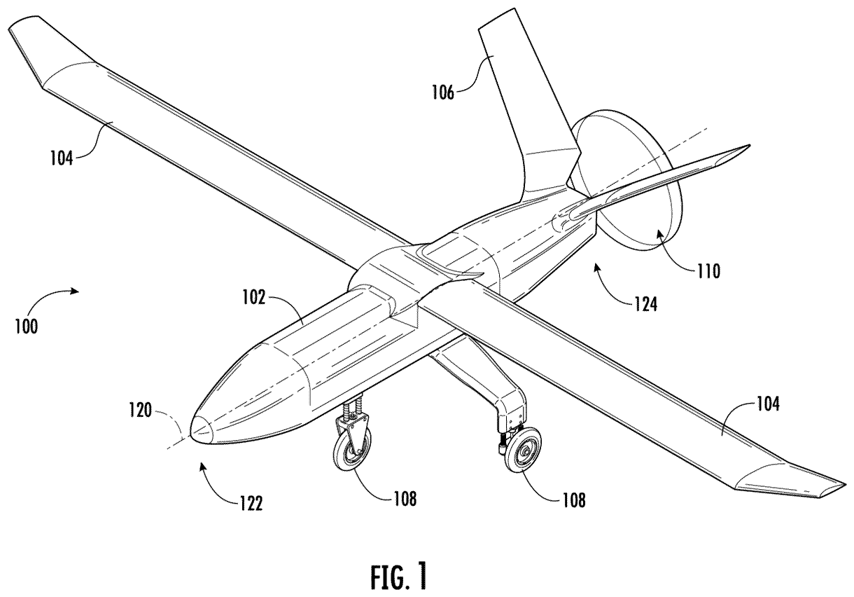

FIG. 1 illustrates a perspective view of an aircraft assembly 100. The aircraft assembly 100 is a vehicle that can achieve flight for various purposes, such as shipping, transportation, and recreation. The aircraft assembly 100 may be configured for on-board crew or may be an unmanned aerial vehicle (UAV). For example, the aircraft assembly 100 can be a UAV equipped for remote aerial sensing.

The aircraft assembly 100 can include a fuselage 102 that extends generally along a longitudinal axis 120 from a forward end 122 to an aft end 124 of the aircraft assembly 100. The aircraft assembly 100 may define a longitudinal direction. As used herein, the term “longitudinal direction” refers to the direction extending parallel or generally parallel to the longitudinal axis 120 of the assembly, which corresponds to the lengthwise dimension of the aircraft assembly 100. As used herein, the term “longitudinally” refers to an orientation, movement, extension, or alignment in the longitudinal direction. The fuselage 102 can form the main body of the aircraft assembly 100 and can be used to house a payload or cargo, crew, passengers, etc. (not shown), for example. Other components of the aircraft assembly 100, such as wings 104, stabilizers 106, and landing gear 108, can be coupled to the fuselage 102. In addition to the illustrated components, the aircraft assembly 100 can also include other aircraft components that can assist with flight or other operational purposes, including, for example, control surfaces (such as ailerons, flaps, elevators, rudders, etc.), payload bays, booms, avionics, control systems, and communication systems.

The fuselage 102 can also house a propulsion system 110. Although illustrated as a propeller-based system, the propulsion system 110 can be any suitable type of propulsion system. Similarly, although the propulsion system 110 is illustrated at the aft end 124 of the fuselage 102, the propulsion system 110 can additionally or alternatively include elements (e.g., propellers, nacelles) positioned at the forward end 122 or on the wings, for example. Similarly, although the stabilizers 106 are illustrated as two stabilizers in a “V” orientation, other numbers and orientations of stabilizers 106 are also contemplated.

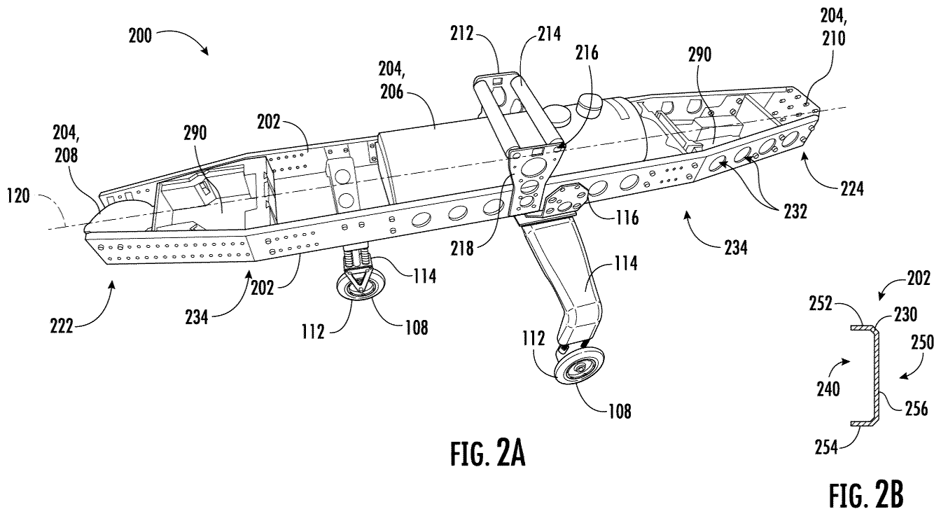

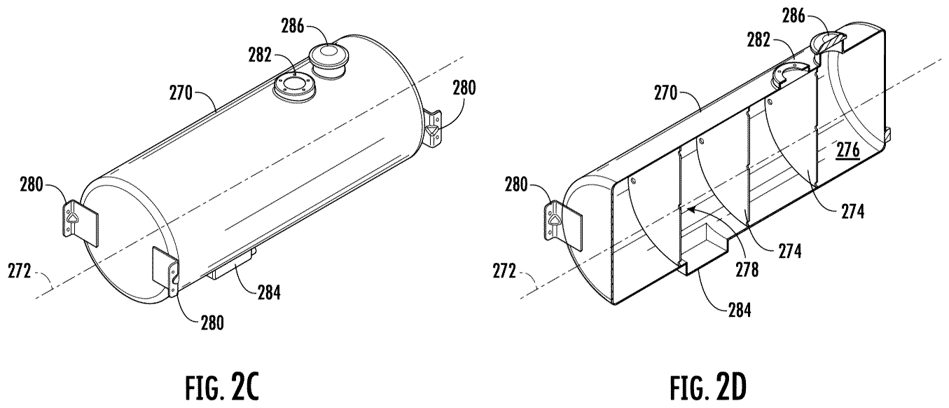

FIG. 2A illustrates a perspective view of an example embodiment of a skeleton 200 that may be used with the aircraft assembly 100. The skeleton 200 can be housed within the fuselage 102 (shown in FIG. 1) and can define the longitudinal axis 120 of the aircraft assembly 100 (and can extend generally along the longitudinal axis 120). As the term “skeleton” suggests, the skeleton 200 can be configured to provide a primary structural support for the aircraft assembly 100. For example, the skeleton 200 can be formed from a metallic material, such as but not limited to aluminum, selected to provide load paths sufficient for loads expected to be sustained by the aircraft assembly 100. Other materials for the skeleton 200 are also contemplated.

In the example embodiment, the skeleton 200 includes longitudinal members 202 extending along opposing lateral sides of the longitudinal axis 120 from a forward end 222 to an aft end 224 of the skeleton 200. The longitudinal members 202 are shaped to be housed within the fuselage 102. For example, as shown in the illustrated embodiment, each of the longitudinal members 202 can be tapered inward toward the longitudinal axis 120 at forward and aft ends 222, 224 of the skeleton 200, in order to accommodate a streamlined exterior shape of the fuselage at the corresponding forward and aft ends 122, 124 of the fuselage (shown in FIG. 1). Other numbers and shapes of the longitudinal members 202, as well as other positions of the longitudinal members 202 relative to the longitudinal axis 120, are also contemplated.

Further in the example embodiment, the skeleton 200 includes one or more transverse members 204 that extend transversely relative to the longitudinal axis 120 and affix the longitudinal members 202 together. For example, the illustrated embodiment includes two plate-shaped transverse members 204 located adjacent to, respectively, the forward and aft ends 222, 224 of the skeleton 200, as well as a cylindrical-shaped transverse member 204 located along a mid-portion, with respect to the longitudinal axis 120, of the skeleton 200. Each transverse member 204 is positioned between, and bolted to, the longitudinal members 202 to affix the longitudinal members 202 together. The transverse members 204 can be configured, individually and in cooperation with each other, to provide primary load paths between the longitudinal members 202. Other positions and shapes for the one or more transverse members 204, as well as other implementations for coupling the one or more transverse members 204 to the longitudinal members 202, are also contemplated.

Alternatively, the longitudinal members 202 can be coupled directly to each other, for example at the forward and aft ends 222, 224, without inclusion of the one or more transverse members 204.

FIG. 2B illustrates a sectional view, taken normal to the longitudinal axis 120 (shown in FIG. 2A), of an example longitudinal member 202. In the example embodiment, the longitudinal member 202 can have a cross-sectional shape 230, normal to the longitudinal axis 120, that resists bending and torsional loads. For example, each longitudinal member 202 can be formed, in part, by bending a sheet metal material into the cross-sectional shape 230. After the cross-sectional shape 230 is formed, the longitudinal member 202 can be bent about a vertical axis at respective locations 234 (shown in FIG. 2A) to create the taper inward toward the longitudinal axis 120 at corresponding forward and aft ends 222, 224. In this context, terms such as “vertical” are “horizontal” are used merely as descriptors with respect to the illustrated orientation of the aircraft assembly 100, and are not intended to limit the disclosure. Portions of the sheet metal can be removed from selected areas 232 (shown in FIG. 2A) to reduce a weight of the skeleton 200 while preserving material in essential load path areas. Other methods of forming the longitudinal members 202 are also contemplated.

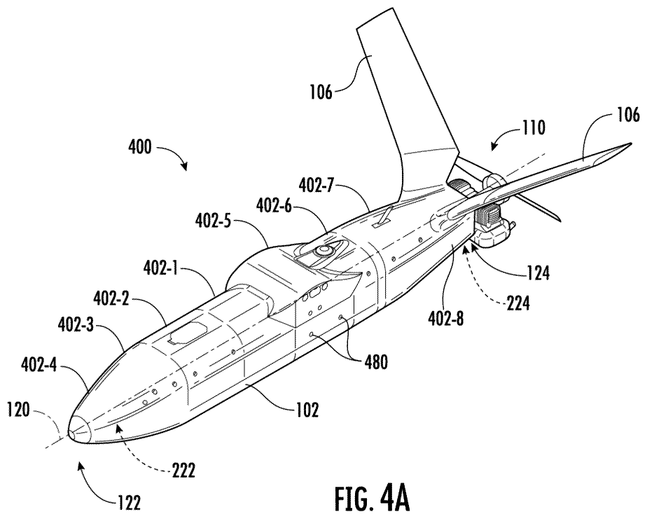

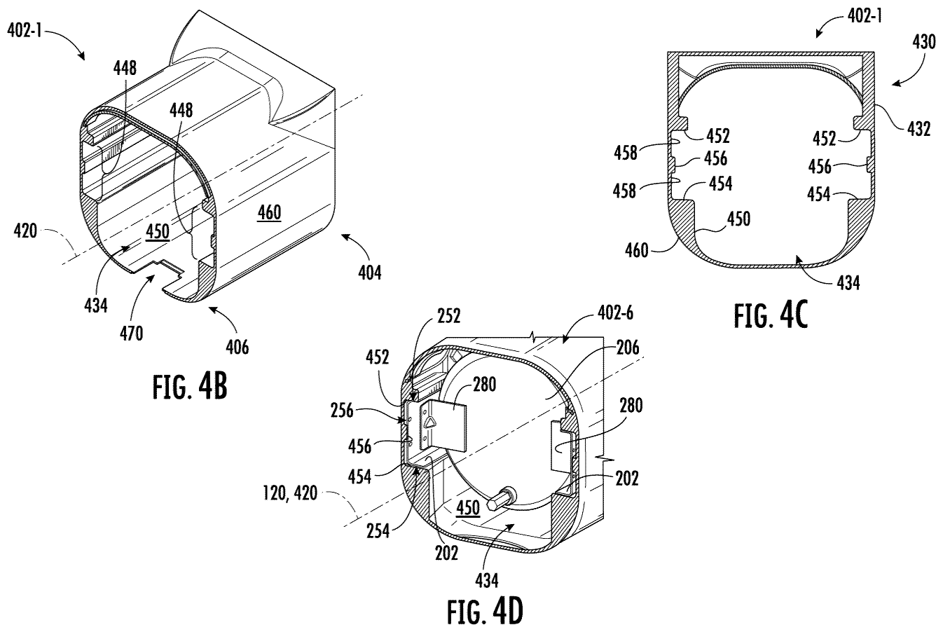

The cross-sectional shape 230 of each longitudinal member 202 defines an inward surface 240, facing the longitudinal axis 120, and an outward surface 250 opposite the inward surface 240. The outward surface 250 can be configured to interface with an inboard surface 450 of components 402 of an outer shell 400 (shown in FIG. 4A) to restrict against movement of the outer shell components 402 in directions other than along the longitudinal axis 120, as will be discussed in more detail below. The outward surface 250 can include a plurality of outward surface segments, such as outward surface segments 252, 254, and 256. For example, in the illustrated embodiment, the outward surface 250 includes first and second outward surface segments 252, 254 extending in respective first and second horizontal planes parallel to the longitudinal axis 120, and a third outward surface segment 256 extending in a vertical plane between the first and second outward surfaces. Other numbers and orientations of the plurality of outward surface segments are also contemplated.

The one or more transverse members 204 can also serve as other components of the aircraft assembly 100. For example, the transverse member 204 located along the mid-portion of the skeleton 200 can also be a fuel tank 206. FIG. 2C illustrates a perspective view of an example embodiment of the fuel tank 206, and FIG. 2D illustrates a cutaway view of the fuel tank 206. More specifically, the fuel tank 206 can be configured to store fuel for feeding to the propulsion system 110 while also providing a load path for distributing loads between the longitudinal members 202 as part of the skeleton 200.

Like the other elements of the skeleton 200, the fuel tank 206 can be formed from a metal, such as aluminum. The fuel tank 206 can include a cylindrical shell defining a cylinder longitudinal axis 272 that can align with the longitudinal axis 120 of the aircraft assembly 100 (shown in FIG. 1). Other shapes and orientations for the fuel tank 206 are also contemplated. For example, but not by way of limitation, the fuel tank 206 can have a rectangular profile normal to the longitudinal axis 120.

The fuel tank 206 can be positioned along the mid-portion of the skeleton 200 (as shown in FIG. 2A) to support bending loads and increase torsional stiffness of the skeleton 200 (and, hence, of the aircraft assembly 100). For example, the skeleton 200 can include tank mount brackets 280 configured to affix the cylindrical shell 270 to the longitudinal members 202. Other implementations for affixing the fuel tank 206 to the longitudinal members 202 are also contemplated. In some embodiments, the dual-purpose use of the fuel tank 206 as one of the transverse members 204 to increase the torsional rigidity of the skeleton 200 advantageously reduces a weight and complexity of the aircraft assembly 100, as compared to the use of a separate, single-purpose torsional stiffener.

In the illustrated embodiment, the fuel tank 206 also includes an inlet 282 for filling the fuel tank with fuel, an outlet 284 for routing fuel from the fuel tank to the propulsion system 110 (shown in FIG. 1), and a vent 286. Other implementations of these features are also contemplated.

The fuel tank 206 can also include one or more baffles 274 configured both to limit fuel slosh within the fuel tank 206, and to further increase a torsional rigidity of the skeleton 200 (and, hence, of the aircraft assembly 100). For example, each baffle 274 can be a thin plate oriented normal to the cylinder longitudinal axis 272 and affixed along a perimeter of the plate to an internal surface 276 of the cylindrical shell 270. Each baffle 274 can extend across substantially an entirety of an internal cross-section of the cylindrical shell 270, and can have one or more orifices 278 extending therethrough to enable constrained fuel flow through the baffle 274. Other implementations for the baffles 274 are also contemplated.

Alternatively, the fuel tank can be implemented separately from the skeleton 200. For example, the fuel tank can be additively manufactured to reduce its weight, and/or can have a shape or position that is not configured to provide a primary load path for loads expected to be sustained by the aircraft assembly 100. In such embodiments, the one or more transverse members 204 can include one or more plate-or other-shaped transverse members (not shown) located along the mid-portion of the skeleton 200.

With reference to FIGS. 2A and 2C, in other embodiments, the propulsion system 110 can be powered by a battery, and the fuel tank 206 can instead be a battery 206 that provides power to the propulsion system and also serves as one of the transverse members 204. For example, the battery can have a cylindrical aluminum casing, with the cylinder longitudinal axis 272 aligned with the longitudinal axis 120 as illustrated (e.g., the cylinder longitudinal axis 272 is colinear with the longitudinal axis 120), configured to support bending loads and increase torsional stiffness of the skeleton 200. Other shapes and orientations for the battery 206 are also contemplated. For example, but not by way of limitation, the battery 206 can have a rectangular profile normal to the longitudinal axis 120.

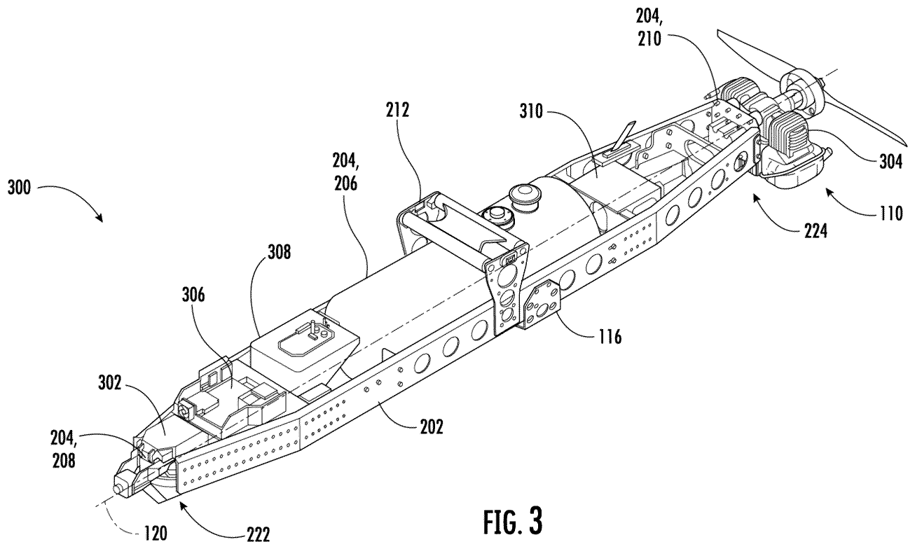

Returning to FIG. 2A, at least one of the one or more transverse members 204 can also serve as a mount for another component of the aircraft assembly 100. For example, in the illustrated embodiment, the plate-shaped transverse member 204 located adjacent to the forward end 222 of the skeleton 200 can also serve as a payload mount 208. More specifically, the payload mount 208 can be configured to couple a payload 302 (shown in FIG. 3) to the skeleton 200, while also providing a load path for distributing loads between the longitudinal members 202 as part of the skeleton 200. Although illustrated adjacent to the forward end 222, other positions for the payload mount 208 are also contemplated. Alternatively, the payload mount can be implemented separately from the skeleton 200.

For another example, in the illustrated embodiment, the plate-shaped transverse member 204 located adjacent to the aft end 224 of the skeleton 200 can also serve as a propulsion system mount 210. More specifically, the propulsion system mount 210 can be configured to couple the propulsion system 110 to the skeleton 200, while also providing a load path for distributing loads between the longitudinal members 202 as part of the skeleton 200. For example, in the illustrated embodiment, the propulsion system mount 210 is oriented normal to the longitudinal axis 120 and is configured to affix and stabilize an external engine block 304 (shown in FIG. 3) of the propulsion system 110 relative to the skeleton 200.

Although illustrated as mounting a propeller-type engine block 304, implementations of the propulsion system mount 210 configured for mounting other types of propulsion systems 110 are also contemplated. Similarly, although illustrated adjacent to the aft end 224, other positions for the propulsion system mount 210 are also contemplated. Alternatively, the propulsion system mount can be implemented separately from the skeleton 200.

The skeleton 200 can also include a wing mount 212 coupled to the longitudinal members 202 and configured to provide a load path for distributing loads sustained by the wings 104 (shown in FIG. 1) to the longitudinal members 202. For example, the wing mount 212 can include one or more receiving members 214 that define channels 216 configured to receive wing coupling elements, such as spars (not shown), from the wings 104. Other implementations for coupling the wing mount 212 to the wings 104 are also contemplated. The wing mount 212 can also include one or more wing mount brackets 218 configured to couple the one or more receiving members 214 to the longitudinal members 202. Other implementations for coupling the wing mount 212 to the longitudinal members 202 are also contemplated.

The skeleton 200 can be configured to accommodate loads sustained by the landing gear 108. For example, the landing gear 108 can include wheels 112 supported by struts 114, and the struts 114 can be configured to provide a load path for distributing loads from the wheels 112 to the longitudinal members 202. In the illustrated embodiment, for example, the struts 114 are affixed directly to the longitudinal members 202 via strut brackets 116. Other types of landing gear 108, and other implementations for coupling the landing gear 108 to the skeleton 200, are also contemplated. In other embodiments, the aircraft assembly 100 does not include landing gear 108.

The skeleton 200 can also be configured to support one or more component bays 290 configured to couple other components (for example, avionics, control systems, or communication systems) of the aircraft assembly 100 to the skeleton 200. The component bays 290 can be shaped to accommodate a size and shape of the other components, rather than primarily to distribute loads. However, the component bays 290 can also include stiffener portions or other structural supports. For example, in the illustrated embodiment, the aircraft assembly 100 includes a first component bay 290 positioned between the forward transverse member 204 and the fuel tank 206, and a second component bay 290 positioned between the fuel tank 206 and the aft transverse member 204. Other numbers or positioning of the component bays are also contemplated. In some embodiments, the component bays 290 can be formed from a plastic material using an additive manufacturing process. Other materials and methods for forming the component bays 290 are also contemplated.

FIG. 3 illustrates a perspective view of an intermediate assembly 300, including the skeleton 200 and example core components installed thereon. In the illustrated embodiment, the core components include the payload 302, coupled to the payload mount 208 adjacent to the forward end 222 of the skeleton 200, as well as the external engine block 304 of the propulsion system 110, coupled to the propulsion system mount 210. In addition, the components include an avionics system 306 mounted in the forward component bay 290 (shown in FIG. 2A), a communications system 308 mounted between the avionics system and the fuel tank 206, and a fuel feed system 310 mounted in the aft component bay 290 (shown in FIG. 2A). Other types of core components, as well as other arrangements of core components relative to the skeleton 200, are also contemplated.

The intermediate assembly 300 can further include supporting components, such as wiring harnesses, fuel lines, and the like, which are not illustrated in FIG. 3 for purposes of clarity.

Notably, in some embodiments, the configuration of the longitudinal members 202 and the one or more transverse members 204 creates an open-access architecture for the intermediate assembly 300 that facilitates an ease of installation of the core components and supporting components on the skeleton 200, as well as an ease of integration and testing of the installed core components. In other words, the configuration of the skeleton 200 can increase production efficiency by enabling open access (that is, access without need to open panels or to uninstall a first component in order to reach a second component, for example) to the installed components in the intermediate assembly 300 for testing and verification, prior to encapsulation within the outer shell 400 (shown in FIG. 4A). System testing of the complete intermediate assembly 300 can be performed before the outer shell 400 is installed, which simplifies test setup and any resulting adjustments or repairs of the components, and the intermediate assembly 300 can then be ready for active duty as the aircraft assembly 100 immediately after installation of the outer shell 400 and wings 104

FIG. 4A illustrates a perspective view of an example outer shell 400 of the aircraft assembly 100, formed from example outer shell components 402-1, 402-2, . . . , 402-8 (collectively, outer shell components 402) coupled to the skeleton 200. FIG. 4B illustrates a perspective view of one of the outer shell components 402-1. FIG. 4C illustrates a sectional view of the outer shell component 402-1, taken normal to a longitudinal axis 420 of the outer shell component 402-1, which defines a cross-sectional profile 430 of the outer shell component. FIG. 4D illustrates a perspective detail view of another one of the outer shell components 402-6 coupled to the skeleton 200.

Each of the outer shell components 402 can be configured to slide over one of the forward end 222 or the aft end 224 of the skeleton 200, in a direction parallel to the longitudinal members 202, and into final position over the intermediate assembly 300 (shown in FIG. 3). For example, in the illustrated embodiment, outer shell components 402-1, 402-2, and 402-3 can be successively received over the forward end 222 and slid aftward along the longitudinal axis 120 into the respective positions illustrated in FIG. 4A. Likewise, outer shell components 402-5, 402-6, 402-7, and 402-8 can be successively received over the aft end 224 and slid forward along the longitudinal axis 120 into the respective positions illustrated in FIG. 4A. The outer shell component 402-4, which is shaped as a closed nose cap, can be partially received over, or otherwise positioned forward with respect to, the forward end 222. Other arrangements for the outer shell components 402 are also contemplated.

One or more of the outer shell components 402 can include one or more slots 470 defined therein. For example, slots 470 can be placed to accommodate access panels (not shown) in the outer shell 400, or to enable external components, such as but not limited to landing gear struts 114 or communication antennas (not shown), to extend through the outer shell 400 to internal connections with the skeleton 200 or one or more components in the intermediate assembly 300. Alternatively, slots 470 can be omitted.

In some embodiments, the ability to slide the outer shell components 402 over the one of the forward end 222 or the aft end 224 into their respective final positions facilitates a rapid and simple conversion of the intermediate assembly 300 into the aircraft assembly 100, potentially “in the field” (that is, a location at or near a location of planned use of the aircraft assembly 100). For example, the intermediate assembly 300 can be assembled, tested, and verified at a manufacturing location remote from the field location, and then shipped to the field (or other) location for local installation of the outer shell components 402, wings 104, and stabilizers 106. This approach enables local, in-the-field customization of the aircraft assembly 100 after more complex integration and testing of core components 302, 304, . . . , 310 and the propulsion system 110 is performed at a factory location. For example, the outer shell components 402 (and, in some cases, the stabilizers 106 and even the wings 104) can be additively manufactured, as discussed in more detail below, at the field location based on up-to-the-minute mission needs. In addition, a desired aerodynamic profile, or alternatively a desired outward appearance, of the aircraft assembly 100 can be selected in the field immediately prior to operation of the aircraft assembly 100 by selecting the wings 104 and/or the outer shell 400 that will result in the selected profile or outward appearance. Similarly, a previously used or previously assembled aircraft assembly 100 can have its aerodynamic profile or outward appearance changed in the field simply by removing the previous set of outer shell components 402 and/or previous wings 104, and replacing with a different set of outer shell components 402 (that is, swapping out one set of outer shell components 402 for another set for which the outboard surfaces 460 define a different selected contour) and/or wings 104. Likewise, more advanced adaptation of the aircraft assembly 100 for different mission profiles can be accomplished by, for example, swapping out at least one of the core components 302, 304, . . . , 310 in the intermediate assembly 300, for example at the field location, prior to installing the outer shell components 402.

In certain embodiments, the stabilizers 106 can be configured to couple directly to the outer shell 400. For example, the aft outer shell component 402-8 can be formed with slots (not shown) and the stabilizers 106 can be formed with root tabs (not shown) that cooperate with the slots to affix the stabilizers 106 to the outer shell component 402-8. Adhesive or fasteners can also be used. Other coupling interfaces for the stabilizers are also contemplated. Different versions of the outer shell component 402-8 having the slots (or other coupling interface) in different locations can enable the outer shell 400 to selectively support a number of stabilizer designs, such as but not limited to a V-tail (illustrated in FIG. 4A), a Y-tail (not shown), a conventional tail (not shown), or an inverted Y-tail (not shown). Alternatively, each stabilizer 106 can also include spars (not shown) that can couple directly to a corresponding one of the longitudinal members 202, for example. Other implementations for coupling the stabilizers 106 to the skeleton 200 are also contemplated.

In some embodiments, to enable the sliding installation of the outer shell components 402 as discussed above, the cross-sectional profile 430 of one or more of the outer shell components 402 (for example, not including end pieces such as the “nose cap” outer shell component 402-4) can include a perimeter 432 that is circumferentially closed about the longitudinal axis 420 and defines a cavity 434 extending completely therethrough along the longitudinal axis 420. The cavity 434 can be sized to enable the intermediate assembly 300 (including the skeleton 200) to pass through the cavity 434 along the longitudinal axis 120 from the one of the forward end 222 or the aft end 224 to an installed position of the outer shell component, when the longitudinal axis 420 of the outer shell component 402 is aligned with the longitudinal axis 120 of the aircraft assembly 100 (as defined by the skeleton 200 within the intermediate assembly 300). In other words, when the longitudinal axes 120 and 420 are aligned, the one of the forward end or the aft end can be passed through the cavity 434, and the outer shell component can be slid along the longitudinal axis 120 to the installed position, in which a portion of the intermediate assembly 300 (including the skeleton 200) remains within the cavity 434. Other configurations for enabling sliding installation of the outer shell components 402 are also contemplated. Alternatively, the outer shell components 402 can be configured for installation onto the intermediate assembly 300 in any suitable fashion.

In certain embodiments, an ability of the skeleton 200 to provide the primary structural load paths for loads sustained by the aircraft assembly 100 enables the outer shell components 402 to be formed from a relatively light-weight plastic material. Moreover, in some such embodiments, the outer shell components 402 can be formed quickly and efficiently using an additive manufacturing process. Additive manufacturing is a manufacturing process that sequentially deposits or “prints” thin layers of material on top of each other to form an object. For example, the outer shell component 402-1 can be formed on a 3D printer (not shown) with the longitudinal axis 420 extending normal to a bed of the printer, by depositing on the bed a first layer of material that defines the cross-sectional profile 430 normal to the longitudinal axis 420 at a first end 404 of the outer shell component 402-1, and successively depositing or “stacking” second, third, fourth, etc. layers atop the first layer until a top layer of the stack defines the cross-sectional profile 430 of a second end 406 of the outer shell component 402-1. In other words, each layer can define the cross-sectional profile 430 of the outer shell component 402-1 at the corresponding station of the layer along the longitudinal axis 420.

In some embodiments, additive manufacturing of the outer shell components 402 can advantageously provide an ability to rapidly design or select, and print out, the outer shell components 402 at a site of installation of the outer shell components 402 onto the intermediate assembly 300, without need to maintain a stock of outer shell components 402 in inventory. Moreover, while known additive manufacturing techniques can result in degradation of one or more mechanical properties of the additively manufactured structure relative to more traditional methods of manufacture, the ability of the skeleton 200 to provide the primary structural load paths for the aircraft assembly 100 can negate any structural strength disadvantage in the use of additively manufactured outer shell components 402. Other materials and other methods of manufacture for the outer shell components 402 are also contemplated.

In some embodiments, additive manufacture of the stabilizers 106 can also be advantageous for substantially the same reasons discussed above with respect to additive manufacture of the outer shell components 402. Other implementations for forming the stabilizers 106 are also contemplated.

In certain embodiments, as noted above, the outer shell components 402 can be configured to interface with the outward surface 250 of each of the longitudinal members 202 to restrict against movement of the outer shell components 402 in a plane normal to the longitudinal axis 120. More specifically, the outer shell components 402 can define an inboard surface 450, adjacent to the cavity 434, and an opposite outboard surface 460 that defines a visible contour of the fuselage 102. The inboard surface 450 can be configured to interface with the outward surface 250 of each of the longitudinal members 202 to restrict against movement of the outer shell components 402 in directions other than along the longitudinal axis 120.

For example, the inboard surface 450 can include a plurality of sets 448 of inboard surface segments, such as surface segments 452, 454, and 456. Each set 448 can be configured for positioning adjacent to the outward surface segments of a corresponding one of the longitudinal members 202. Each set 448 may define a “C” shaped interface to interface with a corresponding one of the longitudinal members 202 to transfer bending and torsional loads between the outer shell component 402 and the corresponding longitudinal member 202. More specifically, when the longitudinal axis 420 is aligned with the longitudinal axis 120 of the skeleton 200 and the outer shell component 402 is slid into position over the intermediate assembly 300, each set 448 of the first, second, and third inboard surface segments 452, 454, and 456 is aligned in a substantially face-to-face relationship with, respectively, the first, second, and third outward surface segments 252, 254, and 256 of a corresponding one of the longitudinal members 202. Other configurations for the plurality of sets 448 of inboard surface segments are contemplated. For example, the set may include two surface segments, such as segment 452 and either segment 454 or 456, or segment 454 and segment 456. In yet another example, the set may include four, five, or six or more surface segments.

For example, in the illustrated embodiment, the inboard surface 450 includes two sets 448 of inboard surface segments 452, 454, and 456. In each set, the first and second inboard surface segments 452 and 454 extend generally in respective first and second horizontal planes parallel to the longitudinal axis 420, and the third inboard surface segment 456 extends generally in a vertical plane between the first and second inboard surface segments. Notably, the third inboard surface segment 456 can extend over less than an entirety of a distance between the first and second inboard surface segments 452 and 454. For example, in the illustrated embodiment, the third inboard surface segment 456 is positioned between upper and lower recessed inboard surface segments 458 that are recessed from the longitudinal axis 420, relative to the third inboard surface segment 456. A correspondingly reduced length of the third inboard surface segment 456 can reduce friction forces between the third inboard surface segment 456 and the third outward surface segment 256 of the longitudinal member 202 when forces sustained by the outer shell 400 cause contact therebetween. In other examples, the third inboard surface segment 456 extends the entirety of the distance between the first and second inboard surface segment 452 and 454. In other examples, the set 448 includes a plurality of third inboard surface segments 456.

When the outer shell component 402 is slid into position over the intermediate assembly 300, the first inboard surface segment 452 is in a substantially face-to-face relationship with the first outward surface segment 252 of a corresponding one of the longitudinal members 202, the second inboard surface segment 454 is in a substantially face-to-face relationship with the second outward surface segment 254 of the corresponding longitudinal member 202, and the third inboard surface segment 456 is in a substantially face-to-face relationship with the third outward surface segment 256 of the corresponding longitudinal member 202. The face-to-face relationships between inboard surface segments 452 and outward surface segments 252 and between inboard surface segments 454 and outward surface segments 254 constrain vertical movement of the outer shell components 402 relative to the skeleton 200, while the face-to-face relationships between inboard surface segments 456 and outward surface segments 256 on opposing sides of the longitudinal axis 120 constrain horizontal movement of the outer shell components 402 relative to the skeleton 200 Other numbers and orientations of the plurality of inboard surface segments of the outer shell component 402 to interface with the plurality of outward surface segments of the longitudinal members 202 to constrain relative movement in the plane normal to the longitudinal axis 120 are also contemplated.

The inboard surface 450 can be sized to create a clearance gap, rather than an interference fit, between the surfaces in the face-to-face relationships. The clearance gap can facilitate sliding the outer shell components 402 into place over the intermediate assembly 300 during initial assembly, as discussed above. Moreover, the clearance gap can facilitate movement of the outer shell components 402 relative to the skeleton 200 in a direction parallel to the longitudinal axis 120 during operation of the aircraft assembly 100.

More specifically, a coefficient of thermal expansion of, for example, an aluminum used to form the skeleton 200 can be one and a half times, such as two times, such as three times greater than a coefficient of thermal expansion of, for example, a plastic used to additively manufacture the outer shell components 402. In some embodiments, solely a single one of the outer shell components 402 is longitudinally fixed relative to the skeleton 200 (that is, affixed to the skeleton such that relative movement in the direction parallel to the longitudinal axis 120 is substantially prevented). The sole longitudinally fixed outer shell component 402 can also be referred to as the “longitudinally constrained” outer shell component 402. For example, the sole longitudinally constrained outer shell component 402 can be proximate to a central longitudinal location along the longitudinal axis 120, such as the outer shell component 402-5. Other locations for the sole longitudinally constrained outer shell component 402 are also contemplated.

The outer shell components 402 can be connected together in a longitudinal sequence extending forward and aftward of the longitudinally constrained outer shell component 402 to form the outer shell 400. Accordingly, as the longitudinal members 202 expand or contract along the longitudinal axis 120 to a different extent from the outer shell components 402 in response to temperature changes, the outer shell components 402 forward and aft of the longitudinally constrained outer shell component 402 can accommodate the differential expansion by sliding along the longitudinal members 202 parallel to the longitudinal axis 120, while the interfaces between the inboard surface 450 of the remaining outer shell components 402 and the outward surface 250 restrain relative movement in the plane normal to the longitudinal axis 120.

For example, the sole longitudinally constrained outer shell component 402 can be directly affixed to the skeleton 200 via fasteners 480 extending through the outer shell component 402-5 into each of the longitudinal members 202 to restrain relative movement parallel to the longitudinal axis 120. Additionally or alternatively, adhesive can be used to directly affix the sole longitudinally constrained outer shell component 402 to the longitudinal members 202. Other implementations for affixing the longitudinally constrained outer shell component 402-5 to the skeleton 200 to restrain relative longitudinal movement are also contemplated.

In some embodiments, the outer shell components 402 can be connected together in the longitudinal sequence extending forward and aftward of the longitudinally constrained outer shell component 402 by affixing at least one of the first and second ends 404, 406 of each of the outer shell components 402 to an adjacent one of the first and second ends 404, 406 of an adjacent one of the outer shell components 402. In summary, the outer shell components 402 are coupled together in longitudinal sequence to form the cohesive outer shell 400, but only one of the outer shell components 402 (that is, the longitudinally constrained outer shell component 402-5) is longitudinally fixed to the skeleton 200. Loads sustained by the outer shell 400 can be transferred to the skeleton 200 through the sole longitudinally constrained outer shell component 402-5 and, to an extent the loads cause the inboard surface 450 of any of the outer shell components 402 to contact the outward surface 250 of any of the longitudinal members 202, through those contact areas. As noted above, the remaining outer shell components 402 can also slide along the longitudinal members 202 to accommodate differential thermal expansion in response to a temperature change.

For example, in the illustrated embodiment, the first end 404 of the longitudinally constrained outer shell component 402-5 can be affixed to the second end 406 of the aftward adjacent outer shell component 402-6, and the second end 406 of the longitudinally constrained outer shell component 402-5 can be affixed to the first end 404 of the forward adjacent outer shell component 402-1. Similarly, the first end 404 of the outer shell component 402-6 can be affixed to the second end 406 of the next aftward adjacent outer shell component 402-7, and the first end 404 of the outer shell component 402-7 can be affixed to the second end 406 of the next aftward adjacent outer shell component 402-8. Likewise, the second end 406 of the outer shell component 402-1 can be affixed to the first end 404 of the forward adjacent outer shell component 402-2, the second end 406 of the outer shell component 402-2 can be affixed to the first end 404 of the next forward adjacent outer shell component 402-3, and the second end 406 of the outer shell component 402-3 can be affixed to the first end 404 of the next forward adjacent outer shell component 402-4.

For example, each pair of adjacent ends 404, 406 can be affixed using one or more of fasteners or adhesive. Other implementations for affixing the pairs of adjacent ends 404, 406 are also contemplated.

In alternative embodiments, more than one outer shell component 402 can be affixed to the skeleton 200 to restrain relative movement in the direction parallel to the longitudinal axis 120.

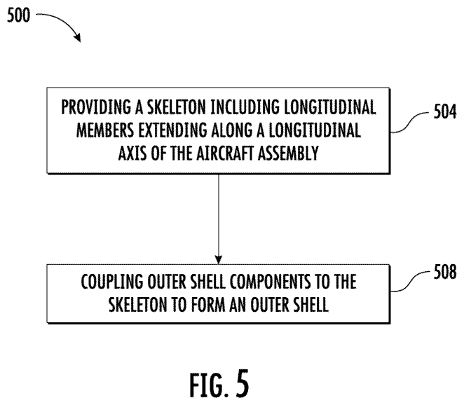

FIG. 5 is a flow diagram illustrating an example method 500 for assembling an aircraft assembly. The method 500 can be used while forming any of the aircraft assemblies described herein, including, for example, embodiments of the aircraft assembly 100 described in FIGS. 1-4D. The method 500 can include one or more steps, such as: providing a skeleton including longitudinal members extending along a longitudinal axis of the aircraft assembly, wherein each of the longitudinal members includes an outward surface (504); and coupling outer shell components to the skeleton to form an outer shell, wherein each of the outer shell components includes an inboard surface, and wherein the inboard surface is configured to interface with the outward surface of each of the longitudinal members to restrict against movement of the outer shell components in directions other than along the longitudinal axis (508).

In some embodiments, the step of coupling the outer shell components to the skeleton includes sliding one or more of the outer shell components along the longitudinal axis from one of a forward end or an aft end of the skeleton to an installed position of the outer shell component.

In certain embodiments, each of the one or more outer shell components includes a perimeter that is circumferentially closed and defines a cavity extending completely therethrough, and the step of sliding the one or more components includes, for each outer shell component of the one or more outer shell components: aligning a longitudinal axis of the outer shell component with the longitudinal axis of the aircraft assembly; passing the one of the forward end or the aft end through the cavity; and sliding the outer shell component along the longitudinal axis of the aircraft assembly to the installed position.

In some embodiments, the outward surface includes a plurality of outward surface segments, the inboard surface includes a plurality of sets of inboard surface segments, and the step of coupling the outer shell components to the skeleton includes positioning each of the sets adjacent to the outward surface segments of a corresponding one of the longitudinal members.

In certain embodiments, the plurality of outward surface segments includes first and second outward surface segments, extending in respective first and second horizontal planes parallel to the longitudinal axis, and a third outward surface segment extending in a vertical plane between the first and second outward surfaces; the plurality of inboard surface segments includes first, second, and third inboard surface segments; and the step of positioning each of the sets includes aligning the first, second, and third inboard surface segments in a substantially face-to-face relationship with, respectively, the first, second, and third outward surface segments of the corresponding one of the longitudinal members.

In some embodiments, the step of coupling the outer shell components to the skeleton includes longitudinally fixing solely a single one of the outer shell components relative to the skeleton.

In certain embodiments, the step of longitudinally fixing solely the single one of the outer shell components includes directly affixing the single one to the skeleton via fasteners extending through the single one into each of the longitudinal members.

In some embodiments, the step of coupling the outer shell components to the skeleton includes connecting the outer shell components together in a longitudinal sequence extending forward and aftward of the single one of the outer shell components.

In certain embodiments, the outer shell components each extend longitudinally from a first end to a second end, and the step of connecting the outer shell components together includes affixing at least one of the first and second ends of each of the outer shell components to an adjacent one of the first and second ends of an adjacent one of the outer shell components

In some embodiments, the skeleton is formed from a first material having a first coefficient of thermal expansion, the outer shell components are formed from a second material having a second coefficient of thermal expansion that differs from the first coefficient of thermal expansion, and the step of coupling the outer shell components to the skeleton includes interfacing the inboard surface with the outward surface of each of the longitudinal members to enable sliding motion, along the longitudinal axis, of the outer shell relative to the skeleton in response to temperature changes.

In certain embodiments, the step of providing the skeleton includes affixing the longitudinal members together via one or more transverse members that extend transversely relative to the longitudinal axis.

In some embodiments, the step of affixing the longitudinal members together via the one or more transverse members includes affixing a fuel tank along a mid-portion of the skeleton.

In certain embodiments, the fuel tank includes a cylindrical shell defining a cylinder longitudinal axis, and wherein the step of affixing the fuel tank includes aligning the cylinder longitudinal axis with the longitudinal axis of the aircraft assembly.

In some embodiments, the steps further include, prior to the step of coupling the outer shell components to the skeleton, forming an intermediate assembly by installing one or more core components of the aircraft assembly on the skeleton.

In certain embodiments, the step of installing the one or more core components includes installing at least one of a payload, an external engine block, an avionics system, a communications system, or a fuel feed system to the skeleton.

In some embodiments, the steps further include, prior to the step of coupling the outer shell components to the skeleton, testing of the installed core components, wherein a configuration of the skeleton enables open access to the core components in the intermediate assembly for testing.

In certain embodiments, the step of coupling the outer shell components to the skeleton is performed at a field location, and the step of forming the intermediate assembly is performed at a manufacturing location remote from the field location.

In some embodiments, the steps further include selecting, at the field location, the outer shell components based on a desired aerodynamic profile or a desired outward appearance of the aircraft assembly.

In certain embodiments, the steps further include, prior to the step of coupling the outer shell components to the skeleton. decoupling prior outer shell components from the skeleton at the field location, wherein the prior outer shell components define a first visible contour of a fuselage of the aircraft assembly that differs from a second visible contour of the fuselage defined by the coupled outer shell components.

In some embodiments, the steps further include swapping out at least one of the one or more core components in the intermediate assembly at the field location.

In certain embodiments, the steps further include additively manufacturing the outer shell components.

In some embodiments, the step of additively manufacturing the outer shell components is performed at a field location.

In certain embodiments, each of the outer shell components extends from a first end to a second end and defines a component longitudinal axis and a cross-sectional profile normal to the component longitudinal axis, and the step of additively manufacturing the outer shell components includes, for each outer shell component: depositing a first layer of material that defines the cross-sectional profile at the first end of the outer shell component; and successively stacking layers atop the first layer to a top layer, wherein the top layer defines the cross-sectional profile at the second end, and wherein each layer defines the cross-sectional profile at a corresponding station along the component longitudinal axis.

Other steps are also contemplated in light of the figures and of the description herein.

This disclosure is not intended to be exhaustive or to limit the present technology to the precise forms disclosed herein. For instance, although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Furthermore, although steps of methods may be presented herein in a particular order, in alternative embodiments the steps may have another suitable order, including being performed concurrently in a parallel process when possible.

Certain aspects of the present technology disclosed in the context of particular embodiments can be combined or eliminated in other embodiments. Furthermore, while advantages associated with certain embodiments may have been disclosed in the context of those embodiments, other embodiments can also exhibit such advantages, and not all embodiments need necessarily exhibit such advantages or other advantages disclosed herein to fall within the scope of the present technology. The embodiments have been particularly shown and described, but it will be understood that various changes in form and details may be made. For example, although various embodiments have been described as having particular features and/or combinations of components, other embodiments are possible having any combination or sub-combination of any features and/or components from any of the embodiments described herein. The specific configurations of the various components can also be varied. For example, the size and specific shape of the various components can be different than the embodiments shown, while still providing the functions as described herein. Furthermore, in some examples, the illustrations describing some embodiments can hide particular features of the embodiment so as to not obscure the illustration of other features within the embodiment. Accordingly, this disclosure and associated technology can encompass other embodiments not expressly shown and/or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like are used throughout this disclosure to mean including at least the recited feature(s) such that any greater number of the same feature(s) or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments. Where appropriate, relative terms, such as “about,” “substantially,” “generally”, and “approximately,” can be understood to incorporate standard tolerances. For example, two members that are “substantially parallel” may be understood to mean two members that are parallel within standard engineering tolerances, such as within 5 degrees, such as within 3 degrees, such as within 1 degree.

We claim:

1. An aircraft assembly defining a longitudinal axis that defines a longitudinal direction, the aircraft assembly comprising:
a skeleton including longitudinal members, each longitudinal member extending in the longitudinal direction, wherein each of the longitudinal members includes an outward surface; and
an outer shell formed from outer shell components, wherein each of the outer shell components includes an inboard surface, and wherein the inboard surface is configured to interface with the outward surface of each of the longitudinal members to restrict against movement of the outer shell components in directions other than along the longitudinal direction.

2. The aircraft assembly of claim 1, wherein the outward surface includes a plurality of outward surface segments, wherein the inboard surface includes a plurality of sets of inboard surface segments, and wherein each of the sets is configured for positioning adjacent to the outward surface segments of a corresponding one of the longitudinal members.

3. The aircraft assembly of claim 2, wherein the plurality of outward surface segments includes first and second outward surface segments, extending in respective first and second horizontal planes parallel to the longitudinal axis, and a third outward surface segment extending in a vertical plane between the first and second outward surfaces.

4. The aircraft assembly of claim 3, wherein the plurality of inboard surface segments includes first, second, and third inboard surface segments aligned in a substantially face-to-face relationship with, respectively, the first, second, and third outward surface segments of the corresponding one of the longitudinal members.

5. The aircraft assembly of claim 4, wherein the third inboard surface segment extends over less than an entirety of a distance between the first and second inboard surface segments.

6. The aircraft assembly of claim 1, wherein solely a single one of the outer shell components is longitudinally fixed relative to the skeleton.

7. The aircraft assembly of claim 6, wherein the single one of the outer shell components is directly affixed to the skeleton via fasteners extending through the single one of the outer shell components into each of the longitudinal members.

8. The aircraft assembly of claim 6, wherein the outer shell components are connected together in a longitudinal sequence extending forward and aftward of the single one of the outer shell components.

9. The aircraft assembly of claim 8, wherein the outer shell components each extend longitudinally from a first end to a second end, and wherein at least one of the first and second ends of each of the outer shell components is affixed to an adjacent one of the first and second ends of an adjacent one of the outer shell components.

10. The aircraft assembly of claim 6, wherein the skeleton is formed from a first material having a first coefficient of thermal expansion, wherein the outer shell components are formed from a second material having a second coefficient of thermal expansion that differs from the first coefficient of thermal expansion, and wherein the inboard surface is configured to interface with the outward surface of each of the longitudinal members to enable sliding motion, along the longitudinal direction, of the outer shell relative to the skeleton in response to temperature changes.

11. The aircraft assembly of claim 10, wherein the first material includes aluminum.

12. The aircraft assembly of claim 10, wherein the second material includes plastic.

13. The aircraft assembly of claim 1, wherein the skeleton further includes one or more transverse members that extend transversely relative to the longitudinal axis and affix the longitudinal members together.

14. The aircraft assembly of claim 13, wherein the one or more transverse members include a fuel tank located along a mid-portion of the skeleton.

15. The aircraft assembly of claim 14, wherein the fuel tank includes a cylindrical shell defining a cylinder longitudinal axis, and wherein the cylinder longitudinal axis is aligned with the longitudinal axis of the aircraft assembly.

16. The aircraft assembly of claim 15, wherein fuel tank further includes one or more baffles configured both to limit fuel slosh within the fuel tank, and to further increase a torsional rigidity of the skeleton.

17. The aircraft assembly of claim 14, wherein each of the longitudinal members is tapered inward toward the longitudinal axis at forward and aft ends of the skeleton, and wherein the one or more transverse members further include two plate-shaped transverse members located adjacent to, respectively, the forward and aft ends.

18. The aircraft assembly of claim 13, wherein at least one of the one or more transverse members also serves as a mount for another component of the aircraft assembly.

19. The aircraft assembly of claim 1, wherein the outer shell components further include an outboard surface opposite the inboard surface, and wherein the outboard surface of the outer shell components defines a visible contour of a fuselage of the aircraft assembly.

20. The aircraft assembly of claim 1, wherein one or more of the outer shell components includes a perimeter that is circumferentially closed and defines a cavity extending completely therethrough, wherein the cavity is sized to enable the skeleton to pass through the cavity in the longitudinal direction from one of a forward end or an aft end of the skeleton to an installed position of the outer shell component.

21. A method of assembling an aircraft assembly, the aircraft defining a longitudinal axis that defines a longitudinal direction, the method comprising:
providing a skeleton including longitudinal members, each longitudinal member extending in the longitudinal direction, wherein each of the longitudinal members includes an outward surface; and
coupling outer shell components to the skeleton to form an outer shell, wherein each of the outer shell components includes an inboard surface, and wherein the inboard surface is configured to interface with the outward surface of each of the longitudinal members to restrict against movement of the outer shell components in directions other than along the longitudinal direction.

22. The method of claim 21, wherein the step of coupling the outer shell components to the skeleton includes sliding one or more of the outer shell components along the longitudinal direction from one of a forward end or an aft end of the skeleton to an installed position of the outer shell component.

23. The method of claim 22, wherein each of the one or more outer shell components includes a perimeter that is circumferentially closed and defines a cavity extending completely therethrough, and wherein the step of sliding the one or more components includes, for each outer shell component of the one or more outer shell components:
aligning a longitudinal axis of the outer shell component with the longitudinal axis of the aircraft assembly;
passing the one of the forward end or the aft end through the cavity; and
sliding the outer shell component along the longitudinal direction to the installed position.

24. The method of claim 21, wherein the outward surface includes a plurality of outward surface segments, wherein the inboard surface includes a plurality of sets of inboard surface segments, and wherein the step of coupling the outer shell components to the skeleton includes positioning each of the sets adjacent to the outward surface segments of a corresponding one of the longitudinal members.

25. The method of claim 24, wherein the plurality of outward surface segments includes first and second outward surface segments, extending in respective first and second horizontal planes parallel to the longitudinal axis, and a third outward surface segment extending in a vertical plane between the first and second outward surfaces, wherein the plurality of inboard surface segments includes first, second, and third inboard surface segments, and wherein the step of positioning each of the sets includes aligning the first, second, and third inboard surface segments in a substantially face-to-face relationship with, respectively, the first, second, and third outward surface segments of the corresponding one of the longitudinal members.

26. The method of claim 21, wherein the step of coupling the outer shell components to the skeleton includes longitudinally fixing solely a single one of the outer shell components relative to the skeleton.

27. The method of claim 26, wherein the step of longitudinally fixing solely the single one of the outer shell components includes directly affixing the single one to the skeleton via fasteners extending through the single one into each of the longitudinal members.

28. The method of claim 26, wherein the step of coupling the outer shell components to the skeleton includes connecting the outer shell components together in a longitudinal sequence extending forward and aftward of the single one of the outer shell components.

29. The method of claim 28, wherein the outer shell components each extend longitudinally from a first end to a second end, and wherein the step of connecting the outer shell components together includes affixing at least one of the first and second ends of each of the outer shell components to an adjacent one of the first and second ends of an adjacent one of the outer shell components.

30. The method of claim 26, wherein the skeleton is formed from a first material having a first coefficient of thermal expansion, wherein the outer shell components are formed from a second material having a second coefficient of thermal expansion that differs from the first coefficient of thermal expansion, and wherein the step of coupling the outer shell components to the skeleton includes interfacing the inboard surface with the outward surface of each of the longitudinal members to enable sliding motion, along the longitudinal axis, of the outer shell relative to the skeleton in response to temperature changes.

31. The method of claim 21, wherein the step of providing the skeleton includes affixing the longitudinal members together via one or more transverse members that extend transversely relative to the longitudinal axis.

32. The method of claim 31, wherein the step of affixing the longitudinal members together via the one or more transverse members includes affixing a fuel tank along a mid-portion of the skeleton.

33. The method of claim 32, wherein the fuel tank includes a cylindrical shell defining a cylinder longitudinal axis, and wherein the step of affixing the fuel tank includes aligning the cylinder longitudinal axis with the longitudinal axis of the aircraft assembly.

34. The method of claim 21, further comprising, prior to the step of coupling the outer shell components to the skeleton, forming an intermediate assembly by installing one or more core components of the aircraft assembly on the skeleton.

35. The method of claim 34, wherein the step of installing the one or more core components includes installing at least one of a payload, an external engine block, an avionics system, a communications system, or a fuel feed system to the skeleton.

36. The method of claim 34, further comprising, prior to the step of coupling the outer shell components to the skeleton, testing of the installed core components, wherein a configuration of the skeleton enables open access to the core components in the intermediate assembly for testing.

37. The method of claim 34, wherein the step of coupling the outer shell components to the skeleton is performed at a field location, and wherein the step of forming the intermediate assembly is performed at a manufacturing location remote from the field location.

38. The method of claim 37, further comprising selecting, at the field location, the outer shell components based on a desired aerodynamic profile or a desired outward appearance of the aircraft assembly.

39. The method of claim 37, further comprising, prior to the step of coupling the outer shell components to the skeleton, decoupling prior outer shell components from the skeleton at the field location, wherein the prior outer shell components define a first visible contour of a fuselage of the aircraft assembly that differs from a second visible contour of the fuselage defined by the coupled outer shell components.

40. The method of claim 37, further comprising swapping out at least one of the one or more core components in the intermediate assembly at the field location.

41. The method of claim 21, further comprising additively manufacturing the outer shell components.

42. The method of claim 41, wherein the step of additively manufacturing the outer shell components is performed at a field location.

43. The method of claim 41, wherein each of the outer shell components extends from a first end to a second end and defines a component longitudinal axis and a cross-sectional profile normal to the component longitudinal axis, and wherein the step of additively manufacturing the outer shell components includes, for each outer shell component:
depositing a first layer of material that defines the cross-sectional profile at the first end of the outer shell component; and
successively stacking layers atop the first layer to a top layer, wherein the top layer defines the cross-sectional profile at the second end, and wherein each layer defines the cross-sectional profile at a corresponding station along the component longitudinal axis.
